(19) United States
(12) Patent Application Publication
(10) Pub. No.: US 2026/0287191 A1
(43) Pub. Date: Sep. 24, 2026

(54) DUCT VENTILATION FAN

(71) Applicant: MITSUBISHI ELECTRIC CORPORATION, Tokyo (JP)

(72) Inventors: Kenichi SAKODA, Tokyo (JP); Miyu NAKANO, Tokyo (JP); Kazuki OKAMOTO, Tokyo (JP); Yuji AKIBA, Tokyo (JP)

(73) Assignee: MITSUBISHI ELECTRIC CORPORATION, Tokyo (JP)

(21) Appl. No.: 19/479,739

(22) PCT Filed: Jun. 21, 2023
(86) PCT No.: PCT/JP2023/022965

§ 371 Date: Oct. 29, 2025

(51) Int. Cl. F24F 7/06; F04D 17/08; F04D 29/44; F24F 7/00; F24F 13/14

(52) U.S. Cl. CPC F24F 7/065; F04D 17/08; F04D 29/441; F24F 13/14; F24F 2007/001

(57) ABSTRACT

A duct ventilation fan includes a fan casing and a duct connection part communicating with an exhaust port of the fan casing, which includes a diffuser including a first wall, a second wall, a third wall, and a tapered surface disposed at a corner between the first wall and the second wall and decreasing an air passage cross-sectional area of the diffuser along a flow direction of air. The duct connection part includes a shutter and a shutter rotation shaft. When a tapered end of the tapered surface, the shutter rotation shaft, and an outline of the exhaust port are projected on a virtual plane, an extension line of the shutter rotation shaft intersects the third wall and the first wall, and on the virtual plane, the shutter rotation shaft intersects an extension line of the tapered end.

### TECHNICAL FIELD

The present disclosure relates to a duct ventilation fan.

### BACKGROUND ART

A duct ventilation fan is concealed in an opening in a ceiling, sucks air from an air inlet disposed on an indoor side, and discharges the air from a duct connection port connected to a duct on an outdoor side, thereby ventilating indoors. Such a duct ventilation fan includes a fan casing that houses a multi-blade fan, and a duct connection part connected to an exhaust port of the fan casing. The duct connection part causes the fan casing and the duct to communicate with each other. Some duct connection parts include shutters to prevent outside air from flowing into fan casings from ducts and then flowing into the indoor side.

In general, a shutter of the duct connection port is rotatably mounted on a rotation shaft. When the duct ventilation fan operates and air sent from the multi-blade fan collides with the shutter, the shutter rotates and opens the duct connection port. As a result, the duct ventilation fan and the duct communicate with each other. When the multi-blade fan is stopped, the shutter closes the duct connection port to prevent the outside air from flowing into the fan casing. For example, Patent Literature 1 proposes that, to prevent the outside air from flowing into the fan casing, a downstream side end of a shutter when it is closed be formed into a shape bulged to a downstream side of airflow.

### CITATION LIST

### Patent Literature

Patent Literature 1: Japanese Patent No. 6782396

### SUMMARY OF INVENTION

### Technical Problem

When the shutter of Patent Literature 1 is applied to the duct ventilation fan, the shutter is closed under its own weight and closes the duct connection port when the duct ventilation fan is stopped. In such a shutter configuration, the rotation shaft of the shutter is disposed on an upper side of the duct connection port, that is, on an upper side of the duct ventilation fan. However, in a velocity distribution in the exhaust port of the multi-blade fan used for the duct ventilation fan, a velocity on the upper side opposite to the air inlet is greater than a velocity on a lower side. Therefore, a wind pressure when air sent from the multi-blade fan collides with the shutter is high near the rotation shaft of the shutter located on the upper side of the duct connection port, and a torque generated in the shutter is not sufficiently large. As a result, an opening degree at which the shutter is opened is small or unstable, causing problems such as deterioration in air-blowing performance of the duct ventilation fan and generation of abnormal noise.

The present disclosure has been made to solve the above-described problems, and has an object to obtain a duct ventilation fan that stably increases the opening degree of the shutter.

### Solution to Problem

A duct ventilation fan according to an embodiment of the present disclosure includes a fan casing having an intake port and an exhaust port, an impeller housed in the fan casing and configured to rotate about a rotation axis and to discharge air in a radial direction, and a duct connection part having a duct connection port communicating with the exhaust port of the fan casing. The fan casing includes a suction side flat plate disposed opposite to the impeller and having the intake port, a side wall having a scroll shape ranging from a winding start portion to a winding end portion, a diffuser having a cylindrical shape connecting the winding start portion and the winding end portion to the exhaust port, and a tongue portion connecting the winding start portion and the diffuser. The diffuser includes a first wall extending from an end of the side wall that is adjacent to the winding end portion to the exhaust port, a second wall extending to the exhaust port along a same plane as the suction side flat plate, a third wall opposite to the second wall, and a tapered surface disposed at a corner between the first wall and the second wall and decreasing an air passage cross-sectional area of the diffuser along a flow direction of the air in the diffuser. The duct connection part includes a shutter configured to open and close the duct connection port, and a shutter rotation shaft on which the shutter is rotatably mounted. When a tapered end that is a side of the tapered surface that is adjacent to the exhaust port, the shutter rotation shaft, and an outline of the exhaust port are projected on a virtual plane orthogonal to a flow direction of the air flowing through the duct connection port, an extension line of the shutter rotation shaft intersects the third wall and the first wall. On the virtual plane, the shutter rotation shaft intersects an extension line of the tapered end.

### Advantageous Effects of Invention

In the duct ventilation fan according to an embodiment of the present disclosure, by providing the fan casing with the tapered surface, air is guided to a position where a torque for rotating the shutter is increased. Accordingly, an opening degree of the shutter is stably increased, and deterioration in air-blowing performance of the duct ventilation fan and generation of abnormal noise can be prevented or reduced.

### BRIEF DESCRIPTION OF DRAWINGS

FIG. 1 is a schematic view of a duct ventilation fan according to Embodiment 1.

FIG. 2 is a perspective view of a multi-blade fan according to Embodiment 1.

FIG. 3 is a perspective view of a duct connection part according to Embodiment 1.

FIG. 4 is a longitudinal cross-sectional view of the duct connection part according to Embodiment 1.

FIG. 5 is a schematic view of the duct connection part according to Embodiment 1 viewed from a downstream side in an air flow direction.

FIG. 6 shows schematic views for describing wind speed distributions in an exhaust port of a fan casing according to Embodiment 1.

FIG. 7 is a perspective view of the multi-blade fan according to Embodiment 2.

### DESCRIPTION OF EMBODIMENTS

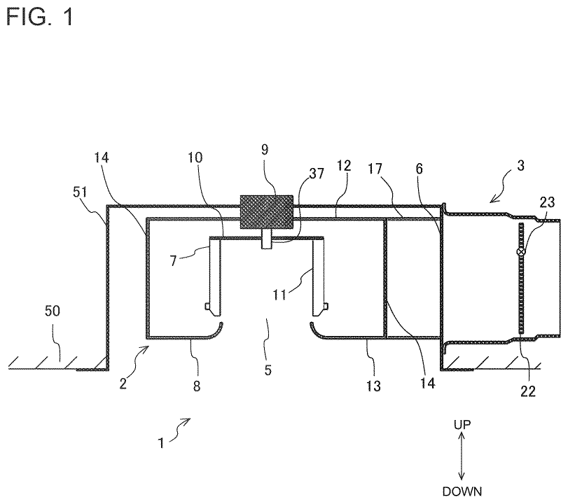

Embodiments of the present disclosure will be described with reference to the drawings. Herein, in the drawings including FIG. 1 to be referred to below, the same reference signs denote the same or equivalent constituent elements, which applies throughout the full text of Embodiments to be described below. Further, in each of Embodiments, constituent elements that are the same as or equivalent to those described in any of the preceding Embodiments are denoted by the same reference signs, and their description may be omitted. The forms of the individual constituent elements described throughout this specification are only exemplary and are not limited to those described in this specification. Furthermore, Embodiments to be described below can be partially combined as long as such combinations do not cause any problem, even if no particular statement is provided.

Note that in each drawing, relative relationships in dimension between constituent elements, the shapes of the constituent elements, or other features of the constituent elements may be different from actual ones. Further, terms indicating directions (such as “up”, “down”, “right”, “left”, “front”, and “rear”) are used as appropriate, for facilitating understanding. However, these expressions are described as such for convenience of explanation, and are not intended to limit arrangement and orientation of a device or a component.

### Embodiment 1

FIG. 1 is a schematic view of a duct ventilation fan 1 according to Embodiment 1. An overview of the duct ventilation fan 1 will be described with reference to FIG. 1. The duct ventilation fan 1 includes a multi-blade fan 2 and a duct connection part 3. The multi-blade fan 2 includes a fan casing 8 that forms a contour, an impeller 7 housed in the fan casing 8, and a drive device 9 connected to the impeller 7. The duct connection part 3 includes a shutter 22 and a shutter rotation shaft 23 on which the shutter 22 is rotatably mounted. The fan casing 8 and the duct connection part 3 communicate with each other.

The multi-blade fan 2 is installed inside a box body 51 concealed in an indoor ceiling 50. The duct connection part 3 can be attached to and detached from the fan casing 8 of the multi-blade fan 2. FIG. 1 shows an example in which the duct connection part 3 communicates with the multi-blade fan 2 via the box body 51, but an exhaust port 6 of the fan casing 8 and the duct connection part 3 may be directly connected. The duct connection part 3 is connected to a duct (not shown) installed above the ceiling and leading to the outdoors.

The fan casing 8 is a scroll-type fan casing that houses the entire impeller 7 in its internal space. The fan casing 8 includes a suction side flat plate 13 facing a space below the ceiling 50, a main plate side flat plate 12 opposite to the suction side flat plate 13, a side wall 14 connecting the suction side flat plate 13 and the main plate side flat plate 12, and a diffuser 17 connected to the suction side flat plate 13, the main plate side flat plate 12, and the side wall 14.

The suction side flat plate 13 is provided with an intake port 5 that opens toward the space below the ceiling 50. The impeller 7 is interposed between the suction side flat plate 13 and the main plate side flat plate 12. The impeller 7 includes a main plate 10. The drive device 9 is connected to the main plate side flat plate 12, and the fan casing 8 is connected to the box body 51 via the drive device 9.

The impeller 7 is rotated by rotary drive of the drive device 9, and a centrifugal force generated by the rotation forcibly discharges air radially outward from the impeller 7. The drive device 9 is, for example, a motor. The impeller 7 includes the main plate 10 to which blades 11 are attached. The main plate 10 is a disk connected to a rotation shaft of the drive device 9 and rotates with rotation of the rotation shaft of the drive device 9. In Embodiment 1, the rotation shaft of the drive device 9 is fixed to the main plate 10, and the rotation shaft of the drive device 9 serves as a rotation axis 37 of the impeller 7. Side walls or a lower end face of the drive device 9 connected to the impeller 7 is fixed to the main plate side flat plate 12 of the fan casing 8.

The diffuser 17 is cylindrical, and an opening adjacent to the duct connection part 3 is the exhaust port 6 of the fan casing 8. The duct ventilation fan 1 sucks air into the inside of the fan casing 8 from the intake port 5 as the impeller 7 is rotated by the drive device 9. The air sucked into the fan casing 8 flows into the duct connection part 3 through the exhaust port 6. The air that has flowed into the duct connection part 3 flows out to the outdoors through the duct. Thus, the duct ventilation fan 1 forms a part of an air passage for indoor air to flow out to the outdoors. Note that, to prevent foreign matter from entering the fan casing 8, a removable indoor grille (not shown) may be disposed below the intake port 5.

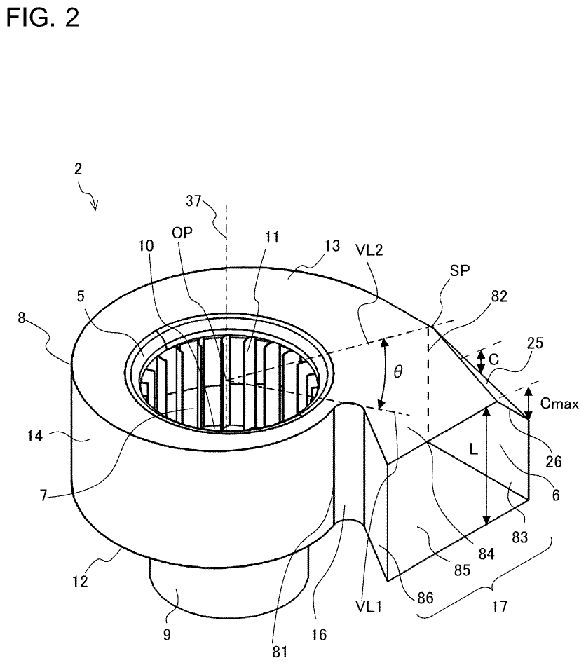

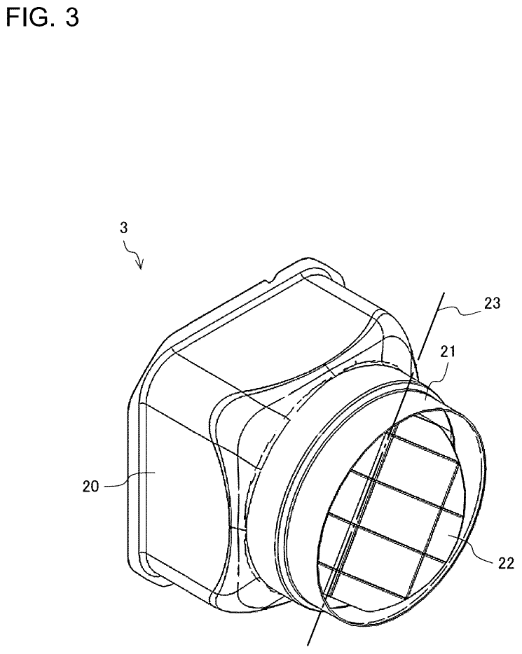

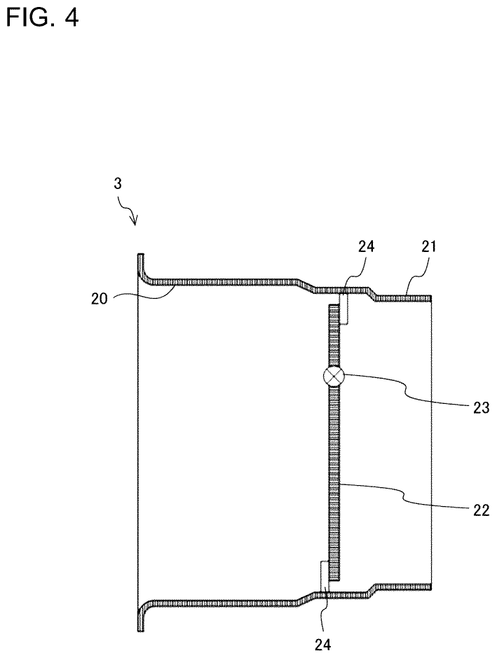

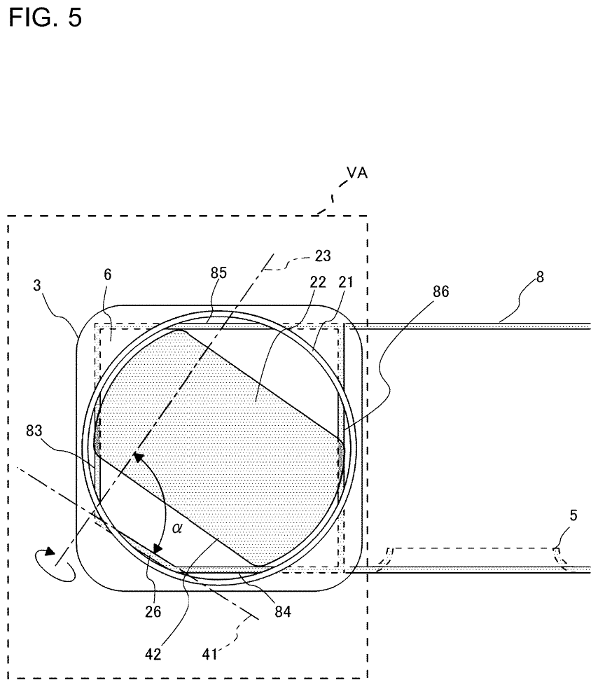

Next, the duct ventilation fan 1 will be described in detail with reference to FIGS. 2 to 5. FIG. 2 is a perspective view of the multi-blade fan 2 according to Embodiment 1. FIG. 3 is a perspective view of the duct connection part 3 according to Embodiment 1. FIG. 4 is a longitudinal cross-sectional view of the duct connection part 3 according to Embodiment 1. FIG. 5 is a schematic view of the duct connection part 3 according to Embodiment 1 viewed from a downstream side in an air flow direction. FIGS. 3 to 5 show the duct connection part 3 in an orientation when the duct connection part 3 is installed above the ceiling, and an up-down direction of drawing sheets in FIGS. 3 to 5 coincides with an up-down direction of a drawing sheet in FIG. 1.

As shown in FIG. 2, the impeller 7 includes a plurality of blades 11. The plurality of blades 11 are disposed with their base ends fixed on a surface of the main plate 10 (see FIG. 1) on a circumference centered on the rotation axis 37. Each of the blades 11 is disposed in a direction from the surface of the main plate 10 toward the intake port 5. Each of the blades 11 is disposed at regular intervals from each other near an outer peripheral edge on the surface of the main plate 10, either parallel to the radial direction or with an inclination of a predetermined angle to the radial direction. Each of the blades 11 is installed nearly perpendicularly to the main plate 10.

The fan casing 8 has a scroll shape that forms a substantially cylindrical space inside and is, for example, a hollow cylinder. The shape of the space formed inside the fan casing 8 is not limited to the cylindrical shape, and may be, for example, a columnar shape with a polygonal cross-section. The suction side flat plate 13 and the main plate side flat plate 12 of the fan casing 8 are disposed orthogonally to the rotation axis 37 and opposite to each other. The side wall 14 connects an outer edge portion of the suction side flat plate 13 and an outer edge portion of the main plate side flat plate 12, and extends around an outer periphery of the impeller 7. As shown in FIG. 2, the side wall 14 extends in a scroll shape from a winding start portion 81 to a winding end portion 82.

The fan casing 8 further includes the diffuser 17 having a cylindrical shape and disposed between the exhaust port 6 and the winding start portion 81 and the winding end portion 82. The diffuser 17 is a hollow pipe with a substantially rectangular air passage cross-section orthogonal to the air flow direction. The air discharged radially outward from the impeller 7 flows out of the exhaust port 6 through the inside of the diffuser 17.

The diffuser 17 includes a first wall 83 extending from an end of the side wall 14 that is adjacent to the winding end portion 82 to the exhaust port 6, a second wall 84 extending to the exhaust port 6 along the same plane as the suction side flat plate 13, a third wall 85 opposite to the second wall 84, and a fourth wall 86 connecting the second wall 84 and the third wall 85. The third wall 85 extends to the exhaust port 6 along the same plane as the main plate side flat plate 12. The fourth wall 86 is connected to the winding start portion 81 of the side wall 14 via a tongue portion 16, which will be described later.

The first wall 83 is disposed at a predetermined angle with the fourth wall 86 such that a cross-sectional area of the air passage of the diffuser 17 gradually expands toward the exhaust port 6, that is, along the air flow direction. In FIG. 2, the fourth wall 86 is inclined outward toward the exhaust port 6 such that the cross-sectional area of the air passage of the diffuser 17 expands toward the exhaust port 6.

A tapered surface 25 is disposed at a corner between the first wall 83 and the second wall 84. The tapered surface 25 has, as a starting point SP, a point at which the end of the side wall 14 that is adjacent to the winding end portion 82, the first wall 83, and the second wall 84 contact, and is inclined toward a center of the exhaust port 6 while expanding its surface area along the air flow direction. The cross-sectional area of the air passage of the diffuser 17 decreases along the air flow direction due to the inclination of the tapered surface 25. The tapered surface 25 has a tapered end 26 that is adjacent to the exhaust port 6. In Embodiment 1, as shown in FIG. 2, the tapered end 26 forms a part of an end of the diffuser 17 that is adjacent to the exhaust port 6. In the present disclosure, the tapered end 26 may be referred to as a side of the tapered surface 25 that is adjacent to the exhaust port 6. The exhaust port 6 of the fan casing 8 is a pentagonal opening formed by the first wall 83 to the fourth wall 86 of the diffuser 17 and the tapered surface 25.

In the present disclosure, a distance, in a direction along the rotation axis 37 of the impeller 7, between a portion where the tapered surface 25 contacts the first wall 83 and a portion where the tapered surface 25 contacts the second wall 84 is referred to as a height dimension C of the tapered surface 25. Further, a distance between the second wall 84 and the third wall 85 of the exhaust port 6 in the direction of the rotation axis 37 of the impeller 7 is referred to as a height dimension L of the exhaust port 6. A ridge line that is a boundary between the first wall 83 and the tapered surface 25 is inclined away from the second wall 84 from the starting point SP toward the exhaust port 6, and the height dimension C thus increases from the starting point SP toward the exhaust port 6. Furthermore, the height dimension C of the tapered end 26 is the largest in the tapered surface 25. When a height dimension Cmax is the height dimension C of the tapered end 26, it is desirable for the height dimension Cmax to have a value of Cmax/L in a range of 0.05 or more and 0.2 or less.

The fan casing 8 further includes the tongue portion 16 between the winding start portion 81 and the fourth wall 86. The tongue portion 16 smoothly connects the winding start portion 81 of the side wall 14 and the fourth wall 86 from the suction side flat plate 13 to the main plate side flat plate 12 with a predetermined radius of curvature. The tongue portion 16 serves as a branching point when the flow of the air that has flowed into the fan casing 8 from the intake port 5 through the impeller 7 is collected by the fan casing 8 and flows into the diffuser 17. That is, the flow of the air discharged from the impeller 7 increases in static pressure while passing through the fan casing 8, and the flow of the air that has flowed into the diffuser 17 is at a higher pressure than in the fan casing 8. Due to this pressure difference, the tongue portion 16 has an effect of dividing a flow of air flowing into the fan casing 8 again from the diffuser 17.

Further, the tongue portion 16 is formed with a predetermined radius of curvature. Therefore, even if air collides with the tongue portion 16 when the air flows into the diffuser 17 from the fan casing 8, turbulence to be generated in the tongue portion 16 can be reduced. This makes it possible to prevent deterioration in air-blowing performance and increase in noise. In Embodiment 1, although the radius of curvature of the tongue portion 16 is constant in a direction along the rotation shaft of the drive device 9, the radius of curvature of the tongue portion 16 need not be constant in the direction along the rotation shaft of the drive device 9. For example, the tongue portion 16 may be formed such that the radius of curvature of the tongue portion 16 close to the intake port 5 of the fan casing 8 is greater than the radius of curvature of the tongue portion 16 close to the main plate side flat plate 12.

The intake port 5 is an opening disposed in the suction side flat plate 13 to suck air from the outside of the fan casing 8. To allow the air to flow smoothly, a cross-section of the intake port 5 gradually decreases from the outside to the inside of the fan casing 8. The impeller 7 is disposed at a position where a center of the intake port 5 and the rotation axis 37 substantially coincide with each other.

A gap between the side wall 14 of the fan casing 8 and an outer peripheral end of the impeller 7 expands at a predetermined rate from the tongue portion 16 to the winding end portion 82. This allows the air discharged from the impeller 7 to flow smoothly through the above-described gap. In addition, an air passage area of the air gradually expands from the tongue portion 16 to the winding end portion 82, and the static pressure of the air thus increases efficiently as the air flows through the gap.

As shown in FIG. 2, on a plane along the suction side flat plate 13, when an origin OP is the rotation axis 37 of the impeller 7, a horizontal line connecting the origin OP and the tongue portion 16 is set as a first virtual line VL1. Further, a horizontal line connecting the origin OP and the starting point SP of the tapered surface 25 is set as a second virtual line VL2. Furthermore, when θ is an angle between the first virtual line VL1 and the second virtual line VL2, it is desirable for the angle θ to be in a range of 80 degrees or more and 220 degrees or less.

Next, the duct connection part 3 will be described with reference to FIGS. 3 and 4. The duct connection part 3 includes a duct extension portion 20 and a duct connection port 21. The duct extension portion 20 forms an air passage inside having a rectangular cross-sectional shape to substantially coincide with the exhaust port 6 of the fan casing 8. The duct connection port 21 has a substantially cylindrical shape. The duct connection port 21 is connected to a downstream end of the duct extension portion 20 in the air flow direction. A connection surface between the duct extension portion 20 and the duct connection port 21 is smoothly inclined. The shutter 22 and the shutter rotation shaft 23 are disposed inside the duct connection port 21. Note that in FIG. 3, the shutter rotation shaft 23 and its extension line are indicated by an alternate long and short dash line, and are denoted by reference sign 23.

The shutter 22 is rotatably mounted on the shutter rotation shaft 23. The shutter 22 rotates along the air flow direction due to a wind pressure from the fan casing 8. Therefore, air is discharged from the impeller 7 when the multi-blade fan 2 is in operation, causing the shutter 22 to rotate and open, and the duct connection port 21 to be opened. No air is discharged from the impeller 7 when the multi-blade fan 2 is stopped, and the shutter 22 thus closes under its own weight to close the duct connection port 21.

The shutter 22 has an elongated shape with a minor axis parallel to the shutter rotation shaft 23 and a major axis orthogonal to the shutter rotation shaft 23. The shape of the shutter 22 in Embodiment 1 is such that short sides are arc-shaped and long sides are linear along the major axis. For example, the shape of the shutter 22 may be an elliptical shape, a substantially oval shape, or a rounded rectangular shape with rounded corners.

As shown in FIG. 4, the duct connection port 21 is provided with protrusions 24 for determining a rotation direction of the shutter 22, which rotates due to the wind pressure from the fan casing 8. With the protrusions 24, the shutter 22 does not rotate toward the duct extension portion 20 even if a wind pressure is generated on the shutter 22 due to inflow of outside air from the outdoors to the duct connection port 21 when the multi-blade fan 2 is stopped. Therefore, the shutter 22 keeps the duct connection port 21 closed, making it possible to prevent the outside air from entering an indoor space via the duct ventilation fan 1.

The shutter rotation shaft 23 is disposed on an upper side in a gravity direction, that is, closer to the third wall 85 in the exhaust port 6 than a center of gravity of the shutter 22 when the duct connection part 3 is installed above the ceiling, such that the shutter 22 closes under its own weight to close the duct connection port 21 (see FIG. 5). Further, the shutter rotation shaft 23 is mounted at a predetermined angle to the horizontal direction such that a torque for rotating the shutter 22 is decreased by the wind pressure from the fan casing 8. Such a configuration of the shutter rotation shaft 23 can prevent the shutter 22 from remaining stationary in the open state when the multi-blade fan 2 is stopped. Further, the shutter 22 can also be kept open when the multi-blade fan 2 is operated in a low airflow operation mode.

Next, a relationship among the tapered surface 25, the shutter 22, and the shutter rotation shaft 23 will be described with reference to FIG. 5. FIG. 5 is a schematic view of the duct connection part 3 and the fan casing 8 viewed from the downstream side in the air flow direction, and a portion enclosed by a dotted line is shown as a virtual plane VA orthogonal to the air flow direction. The extension line of the shutter rotation shaft 23 intersects the third wall 85 and the first wall 83 on the virtual plane VA. In Embodiment 1, the extension line of the shutter rotation shaft 23 is inclined from a center of the third wall 85 of the exhaust port 6 toward the first wall 83. The tapered end 26 projected on the virtual plane VA has a linear shape, and an extension line 41 of the tapered end 26 intersects the shutter rotation shaft 23.

When α is an angle between the extension line 41 of the tapered end 26 and the shutter rotation shaft 23, it is desirable for the angle α to be in a range of 60 degrees or more and 110 degrees or less. Further, when the shutter 22 is closed under its own weight, the tapered end 26 is located on an outer side of the duct connection part 3 farther than a bottom end 42 along the major axis of the shutter 22. Herein, the bottom end 42 of the shutter 22 refers to an end, which is the long side of the elongated-shaped shutter 22 and is located at the bottom when the shutter 22 is mounted. In the example of FIG. 5, the linear side of the shutter 22 is the bottom end 42. Note that the shutter 22 and the tapered end 26 do not overlap in the air flow direction.

Note that although not shown in FIG. 5, the duct connection port 21 includes a protruding portion for preventing a space between the shutter 22 in the closed state and an inner edge of the duct connection port 21. In FIG. 5, a space between the shutter 22 and the duct connection port 21 formed at an upper right of the drawing sheet and a space between the shutter 22 and the duct connection port 21 formed at a lower left of the drawing sheet are blocked by the protruding portion. Therefore, when the shutter 22 is closed, the duct connection port 21 is blocked.

Next, an air flow in the duct ventilation fan 1 when the multi-blade fan 2 is in operation will be described. When the impeller 7 rotates, the air inside the impeller 7 is discharged radially outward by the centrifugal force generated by the rotation. Accordingly, air flows into the inside of the impeller 7 from the intake port 5. The air discharged from the impeller 7 flows toward the exhaust port 6 along the side wall 14 of the fan casing 8. A cross-sectional area between impeller 7 and the side wall 14 increases toward a rotation direction of impeller 7. Therefore, the air flowing inside the fan casing 8 gradually increases in static pressure. The air with the increased static pressure flows into the duct extension portion 20 of the duct connection part 3 from the exhaust port 6 via the diffuser 17. The air that has flowed into the duct extension portion 20 collides with the shutter 22 installed in the duct connection port 21, and a wind pressure generated by the collision rotates and opens the shutter 22. When the shutter 22 is opened, the air flows out to the outdoors through the duct connection port 21.

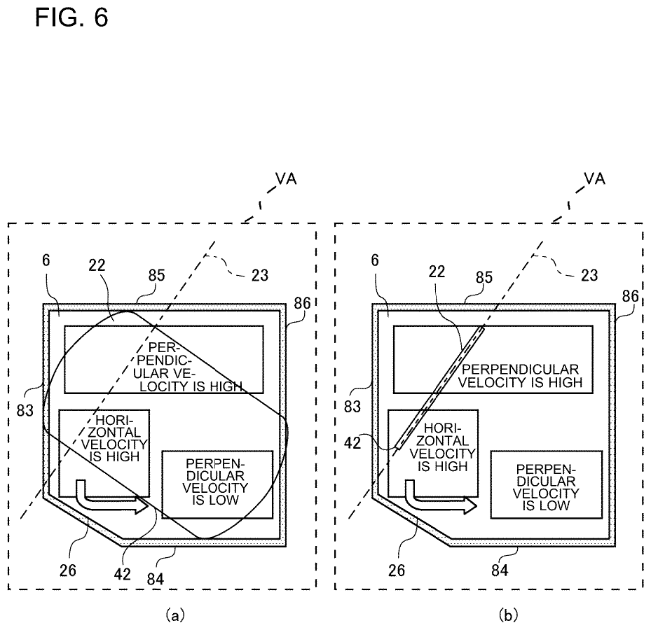

FIG. 6 shows schematic views for describing wind speed distributions in the exhaust port 6 of the fan casing 8 according to Embodiment 1. (a) of FIG. 6 is a schematic view showing the wind speed distribution when the shutter 22 is closed, and (b) of FIG. 6 is a schematic view showing the wind speed distribution when the shutter 22 is open. In (a) and (b) of FIG. 6, the tapered end 26, the shutter 22, the shutter rotation shaft 23, and an outline of the exhaust port 6 are projected on the virtual plane VA orthogonal to the flow direction of the air flowing through the duct connection port 21.

In FIG. 6, regarding a velocity of the air passing through the exhaust port 6, a velocity component in a direction perpendicular to a plane including an opening surface of the exhaust port 6 is described as a perpendicular velocity component and a velocity component parallel to the above-described plane is described as a horizontal velocity component. In general, in the exhaust port 6 of the fan casing 8, the perpendicular velocity component is highest in a region close to the third wall 85, which is flush with the main plate side flat plate 12. Further, the perpendicular velocity component is low in a region of the second wall 84, which is flush with the suction side flat plate 13, that is close to the tongue portion 16 connected to the fourth wall 86. Furthermore, it has been confirmed that in a region of the second wall 84 close to the fourth wall 86, the horizontal velocity component is large and air flows toward the region of the second wall 84 that is close to the tongue portion 16 connected to the fourth wall 86.

Herein, a torque for opening the shutter 22 is integration of a magnitude of the wind pressure generated on the shutter 22 and a distance from a point of application of the wind pressure to the shutter rotation shaft 23. That is, to increase the torque for opening the shutter 22, it is necessary to increase the wind pressure and to increase the distance from the point of application of the wind pressure to the shutter rotation shaft 23.

However, as shown in FIG. 6, in the region near the third wall 85, although the wind pressure is high, the distance from the shutter rotation shaft 23 to the point of application of the wind pressure is short. On the other hand, in the region of the second wall 84 close to the tongue portion 16, although the distance from the shutter rotation shaft 23 to the point of application of the wind pressure is long, the wind pressure is low. Therefore, an opening degree of the shutter 22 decreases when the multi-blade fan 2 is operated, leading to deterioration in the air-blowing performance. Further, when the shutter 22 is open, in the region of the second wall 84 close to the fourth wall 86, the perpendicular velocity component is small, and the air flow thus may become turbulent on a surface of the shutter 22. If the air flow becomes turbulent, a lift force generated in the shutter 22 is unstable, resulting in the generation of abnormal noise.

Herein, the fan casing 8 of the duct ventilation fan 1 according to Embodiment 1 has the tapered surface 25. In detail, the duct ventilation fan 1 according to Embodiment 1 includes the fan casing 8 having the intake port 5 and the exhaust port 6, the impeller 7 housed in the fan casing 8 and rotating about the rotation axis 37 to discharge air in the radial direction, and the duct connection part 3 having the duct connection port 21, which communicates with the exhaust port 6 of the fan casing 8. The fan casing 8 includes the suction side flat plate 13 disposed opposite to the impeller 7 and having the intake port 5, the side wall 14 having the scroll-shape ranging from the winding start portion 81 to the winding end portion 82, the diffuser 17 having the cylindrical shape connecting the winding start portion 81 and the winding end portion 82 to the exhaust port 6, and the tongue portion 16 connecting the winding start portion 81 and the diffuser 17. The diffuser 17 includes the first wall 83 extending from the end of the side wall 14 that is adjacent to the winding end portion 82 to the exhaust port 6, the second wall 84 extending to the exhaust port 6 along the same plane as the suction side flat plate 13, the third wall 85 opposite to the second wall 84, and the tapered surface 25 disposed at the corner between the first wall 83 and the second wall 84 and decreasing the air passage cross-sectional area of the diffuser 17 along the air flow direction of the diffuser 17. The duct connection part 3 includes the shutter 22 configured to open and close the duct connection port 21, and the shutter rotation shaft 23 on which the shutter 22 is rotatably mounted. When the tapered end 26, which is the side of the tapered surface 25 that is adjacent to the exhaust port 6, the shutter rotation shaft 23, and the outline of the exhaust port 6 are projected on the virtual plane VA orthogonal to the flow direction of the air flowing through the duct connection port 21, the extension line of the shutter rotation shaft 23 intersects the third wall 85 and the first wall 83. In addition, on the virtual plane VA, the shutter rotation shaft 23 intersects the extension line 41 of the tapered end 26.

According to the above configuration, the tapered surface 25 is disposed between the first wall 83 and the second wall 84, and the extension line 41 of the tapered end 26 intersects the shutter rotation shaft 23. The air passage cross-sectional area of the diffuser 17 is decreased toward the exhaust port 6 by the tapered surface 25, accelerating the flow of the air flowing toward the exhaust port 6. Further, the tapered surface 25 is inclined toward the center of the exhaust port 6 and the tongue portion 16, and the air having the horizontal velocity component accelerated when the air flows along an inner face of the tapered surface 25 thus heads in a direction of the fourth wall 86 connected to the tongue portion 16. With such an effect of the tapered surface 25, it is possible to increase the wind pressure in the region of the second wall 84 close to the tongue portion 16, in which the distance from the shutter rotation shaft 23 to the point of application of the wind pressure is long. Thus, the torque for opening the shutter 22 increases, and the opening degree of the shutter 22 can be increased. As described above, by providing the fan casing 8 with the tapered surface 25, the duct ventilation fan 1 according to Embodiment 1 can guide air to the position where the torque for rotating the shutter 22 is increased. Accordingly, the opening degree of the shutter 22 can be stably increased, and the deterioration in the air-blowing performance of the duct ventilation fan 1 and the generation of abnormal noise can be prevented or reduced.

Further, in the duct ventilation fan 1 according to Embodiment 1, the shutter 22 has the elongated shape with the minor axis parallel to the shutter rotation shaft 23 and the major axis orthogonal to the shutter rotation shaft 23. The shutter 22 closes under its own weight to close the duct connection port 21, and rotates due to the air flowing out of the exhaust port 6 and opens the duct connection port 21.

Further, on the virtual plane VA, the tapered end 26 is located farther from the center of the exhaust port 6 than the bottom end 42, which is a side along the major axis of the shutter 22. Therefore, the air that has been accelerated when flowing along the tapered surface 25 flows over a surface near the bottom end 42 of the shutter 22 in the open state. The air flows stably over the surface of the bottom end 42 of the shutter 22 even when the shutter 22 is open, and the lift force generated in the shutter 22 is thus stable and the opening degree of the shutter 22 is prevented from being unstable or such unstableness is reduced during operation of the multi-blade fan 2. In addition, the shutter 22 can be stably maintained at the large opening degree, and the air-blowing performance of the duct ventilation fan 1 is thus improved.

Further, in the duct ventilation fan 1 according to Embodiment 1, when, in the direction of the rotation axis 37 of the impeller 7, the height dimension C of the tapered surface 25 is the distance between the boundary portion of the tapered surface 25 and the second wall 84 and the boundary portion of the tapered surface 25 and the first wall 83, the height dimension C increases toward the downstream side in the air flow direction. In the configuration described above, the tapered surface 25 is inclined toward the center of the exhaust port 6 along the air flow direction. Therefore, without changing the dimension or other features of the duct ventilation fan 1, the air can be guided to the position where the torque for opening the shutter 22 increases. Accordingly, the shutter 22 can be stably maintained at the large opening degree, and the air-blowing performance of the duct ventilation fan 1 is thus improved.

Further, in the duct ventilation fan 1 according to Embodiment 1, when, in the direction of the rotation axis 37 of the impeller 7, Cmax is the distance between the boundary portion of the tapered end 26 and the second wall 84 and the boundary portion of the tapered end 26 and the first wall 83 and L is the distance between the second wall 84 and the third wall 85 in the exhaust port 6, the value of Cmax/L is 0.05 or more and 0.2 or less. In the configuration described above, the air flowing through the diffuser 17 to the duct connection part 3 can be guided to the position where the torque for opening the shutter 22 increases. Accordingly, the shutter 22 can be stably maintained at the large opening degree, and the air-blowing performance of the duct ventilation fan 1 is thus improved.

Further, in the duct ventilation fan 1 according to Embodiment 1, when the starting point SP of the tapered surface 25 is the point at which the end of the side wall 14 that is adjacent to the winding end portion 82, the first wall 83, and the second wall 84 contact and the origin OP is the rotation axis 37 of the impeller 7, the angle θ between the first virtual line VL1 connecting the origin OP and the tongue portion 16 and the second virtual line VL2 connecting the origin OP and the starting point SP is 80 degrees or more and 220 degrees or less. In the configuration described above, the air flowing through the diffuser 17 to the duct connection part 3 can be guided to the position where the torque for opening the shutter 22 increases. Accordingly, the shutter 22 can be stably maintained at the large opening degree, and the air-blowing performance of the duct ventilation fan 1 is thus improved.

Further, in the duct ventilation fan 1 according to Embodiment 1, the angle α between the shutter rotation shaft 23 and the extension line 41 of the tapered end 26 is 60 degrees or more and 110 degrees or less. In the configuration described above, the air flowing through the diffuser 17 to the duct connection part 3 can be guided to the position where the torque for opening the shutter 22 increases. Accordingly, the shutter 22 can be stably maintained at the large opening degree, and the air-blowing performance of the duct ventilation fan 1 is thus improved.

### Embodiment 2

In Embodiment 2, differences from Embodiment 1 will be mainly described. In Embodiment 2, constituent elements common to those in Embodiment 1 are given the same reference signs and their description will be omitted. Embodiment 2 differs from Embodiment 1 in that the fan casing 8 according to Embodiment 2 includes a second tapered surface 125.

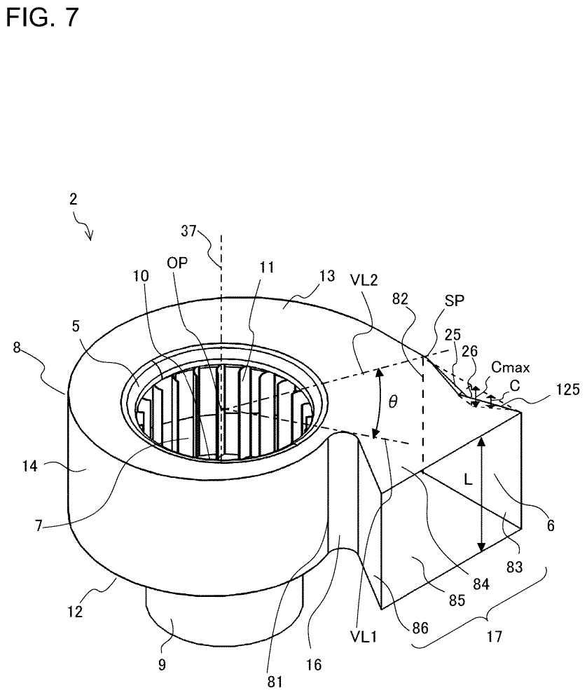

The second tapered surface 125 according to the present disclosure will be described with reference to FIG. 7. FIG. 7 is a perspective view of the multi-blade fan 2 according to Embodiment 2. The tapered surface 25 and the second tapered surface 125 are disposed at the corner between the first wall 83 and the second wall 84 of the diffuser 17. The second tapered surface 125 is disposed continuously with the tapered end 26 of the tapered surface 25. The tapered end 26 according to Embodiment 2 is disposed not in the exhaust port 6 but between the first wall 83 and the second wall 84.

As shown in FIG. 7, in Embodiment 2, the exhaust port 6 of the fan casing 8 is a quadrangular opening formed by the first wall 83 to the fourth wall 86, and the first wall 83 and the second wall 84 are directly connected to each other in the exhaust port 6. The tapered surface 25 is inclined inward of the fan casing 8 from the starting point SP toward the tapered end 26. The second tapered surface 125 is inclined outward of the fan casing 8 from the tapered end 26 toward a boundary portion of the first wall 83 and the second wall 84 of the exhaust port 6. Thus, the tapered surface 25 is inclined toward the center of the exhaust port 6 while expanding its surface area along the air flow direction, and the second tapered surface 125 is inclined outward of the exhaust port 6 while decreasing its surface area along the air flow direction. The air passage cross-sectional area of the diffuser 17 decreases along the air flow direction due to the inclination of the tapered surface 25 and increases along the air flow direction due to the inclination of the second tapered surface 125.

The height of the second tapered surface 125 can also be expressed by the height dimension C, similarly to the height of the tapered surface 25. On the tapered surface 25, a ridge line that is the boundary between the first wall 83 and the tapered surface 25 is inclined away from the second wall 84 from the starting point SP toward the exhaust port 6, and the height dimension C thus increases from the starting point SP toward the exhaust port 6. On the other hand, on the second tapered surface 125, a ridge line that is a boundary between the first wall 83 and the second tapered surface 125 is inclined to approach the second wall 84 from the tapered end 26 toward the exhaust port 6, and the height dimension C thus decreases from the tapered end 26 toward the exhaust port 6.

The height dimension C of the tapered surface 25 and the second tapered surface 125 is greatest at the tapered end 26. As in Embodiment 1, also in Embodiment 2, when the height dimension Cmax is the height dimension C at the tapered end 26, it is desirable for the value of Cmax/L to be in the range of 0.05 or more and 0.2 or less.

Next, effects of the duct ventilation fan 1 according to Embodiment 2 will be described. In general, when the duct connection part is connected to the exhaust port of the fan casing, there are restrictions on the ceiling concealed dimension and workability, and it is sometimes not possible to configure the duct connection part to substantially coincide with the exhaust port. In such a case, to meet the restrictions on the ceiling concealed dimension and the workability, the duct connection part is installed at a position offset from the exhaust port, and an opening of the duct connection part to be connected to the exhaust port is formed large enough to cover the exhaust port.

However, in such a configuration, an air passage cross-sectional area suddenly expands in the duct connection part, causing turbulence in the flow of the air flowing out of the exhaust port and increasing a pressure loss. Further, if a flow of the air flowing in a region, of the suction side flat plate of the exhaust port, close to the fourth wall becomes turbulent, the lift force generated in the shutter becomes unstable, resulting in the generation of abnormal noise.

In the duct ventilation fan 1 according to Embodiment 2, the fan casing 8 includes the second tapered surface 125 disposed between the tapered end 26 and the exhaust port 6. The second tapered surface 125 increases the air passage cross-sectional area of the diffuser 17 along the air flow direction of the diffuser 17. In such a configuration, the air passage cross-sectional area of the diffuser 17 increases toward the exhaust port 6 due to the second tapered surface 125. Therefore, an air passage cross-sectional area of the exhaust port 6 and an air passage cross-sectional area of the duct connection part 3 do not differ greatly, mitigating a sudden expansion of the air passage cross-sectional area in the duct connection part 3. Without the sudden expansion in the air passage cross-sectional area, the turbulence in the flow of the air that has flowed into the duct connection part 3 is prevented or reduced and the lift force generated in the shutter 22 becomes stable.

Further, in the same manner as described in Embodiment 1, with the effect of the tapered surface 25, part of the air flowing through the diffuser 17 can increase the wind pressure in the region of the second wall 84 close to the tongue portion 16, in which the distance from the shutter rotation shaft 23 to the point of application of the wind pressure is long. Thus, the torque for opening the shutter 22 increases, and the opening degree of the shutter 22 can be stably increased. Accordingly, it is possible to prevent or reduce the deterioration in the air-blowing performance of the duct ventilation fan 1 and the generation of abnormal noise.

As described above, in the duct ventilation fan 1 according to Embodiment 2, even when the exhaust port 6 of the fan casing 8 and the duct connection part 3 are installed offset from each other, the sufficient opening degree of the shutter 22 can be obtained and the generation of abnormal noise can be prevented or reduced.

### REFERENCE SIGNS LIST

1: duct ventilation fan, 2: multi-blade fan, 3: duct connection part, 5: intake port, 6: exhaust port, 7: impeller, 8: fan casing, 9: drive device, 10: main plate, 11: blade, 12: main plate side flat plate, 13: suction side flat plate, 14: side wall, 16: tongue portion, 17: diffuser, 20: duct extension portion, 21: duct connection port, 22: shutter, 23: shutter rotation shaft, 24: protrusion, 25: tapered surface, 26: tapered end, 37: rotation axis, 41: extension line, 42: bottom end, 50: ceiling, 51: box body, 81: winding start portion, 82: winding end portion, 83: first wall, 84: second wall, 85: third wall, 86: fourth wall, 125: second tapered surface, C: height dimension, Cmax: height dimension, L: height dimension, OP: origin, SP: starting point, VA: virtual plane, VL1: first virtual line, VL2: second virtual line, α: angle, θ: angle

1. A duct ventilation fan comprising:
a fan casing having an intake port and an exhaust port;
an impeller housed in the fan casing and configured to rotate about a rotation axis and to discharge air in a radial direction; and
a duct connection part having a duct connection port communicating with the exhaust port of the fan casing,
the fan casing including
a suction side flat plate disposed opposite to the impeller and having the intake port,
a side wall having a scroll shape ranging from a winding start portion to a winding end portion,
a diffuser having a cylindrical shape connecting the winding start portion and the winding end portion to the exhaust port, and
a tongue portion connecting the winding start portion and the diffuser,
the diffuser including
a first wall extending from an end of the side wall that is adjacent to the winding end portion to the exhaust port,
a second wall extending to the exhaust port along a same plane as the suction side flat plate,
a third wall opposite to the second wall, and
a tapered surface disposed at a corner between the first wall and the second wall and decreasing an air passage cross-sectional area of the diffuser along a flow direction of the air in the diffuser,
the duct connection part including
a shutter configured to open and close the duct connection port, and
a shutter rotation shaft on which the shutter is rotatably mounted,
when a tapered end that is a side of the tapered surface that is adjacent to the exhaust port, the shutter rotation shaft, and an outline of the exhaust port are projected on a virtual plane orthogonal to a flow direction of the air flowing through the duct connection port, an extension line of the shutter rotation shaft intersecting the third wall and the first wall,
on the virtual plane, the shutter rotation shaft intersecting an extension line of the tapered end.

2. The duct ventilation fan of claim 1,
wherein the shutter
has an elongated shape with a minor axis parallel to the shutter rotation shaft and a major axis orthogonal to the shutter rotation shaft,
is configured to close under own weight of the shutter to close the duct connection port, and
is configured to rotate due to the air flowing out of the exhaust port and opens the duct connection port.

3. The duct ventilation fan of claim 2,
wherein, on the virtual plane,
the tapered end is located farther from a center of the exhaust port than a bottom end along the major axis of the shutter.

4. The duct ventilation fan of any one of claims 1 to 3,
wherein, when, in a direction of the rotation axis of the impeller, a height dimension of the tapered surface is a distance between a boundary portion of the tapered surface and the second wall and a boundary portion of the tapered surface and the first wall,
the height dimension increases toward a downstream side in a flow direction of the air.

5. The duct ventilation fan of any one of claims 1 to 4,
wherein, when, in a direction of the rotation axis of the impeller, Cmax is a distance between a boundary portion of the tapered end and the second wall and a boundary portion of the tapered end and the first wall and L is a distance between the second wall and the third wall in the exhaust port,
a value of Cmax/L is 0.05 or more and 0.2 or less.

6. The duct ventilation fan of any one of claims 1 to 5,
wherein, when a starting point of the tapered surface is a point at which the end of the side wall that is adjacent to the winding end portion, the first wall, and the second wall contact and an origin is the rotation axis of the impeller, an angle θ between a first virtual line VL1 connecting the origin and the tongue portion and a virtual line VL2 connecting the origin and the starting point is 80 degrees or more and 220 degrees or less.

7. The duct ventilation fan of any one of claims 1 to 6,
wherein an angle α between the shutter rotation shaft and the extension line of the tapered end is 60 degrees or more and 110 degrees or less.

8. The duct ventilation fan of any one of claims 1 to 7,
wherein the fan casing
includes a second tapered surface disposed between the tapered end and the exhaust port, and
wherein the second tapered surface increases the air passage cross-sectional area of the diffuser along the flow direction of the air in the diffuser.
